(19) United States
(12) Patent Application Publication
(10) Pub. No.: US 2025/0112000 A1
(43) Pub. Date: Apr. 3, 2025

(54) ICE SHIELDS FOR CUTOUT MOUNTING

(71) Applicant: S&C Electric Company, Chicago, IL (US)

(72) Inventors: Thomas Olin Fanta, Wauconda, IL (US); Sam Jabir, Harwood Heights, IL (US); David Kneip, Chicago, IL (US)

(73) Assignee: S&C Electric Company, Chicago, IL (US)

(21) Appl. No.: 18/898,760

(22) Filed: Sep. 27, 2024

Related U.S. Application Data
(60) Provisional application No. 63/586,014, filed on Sep. 28, 2023.

(51) Int. Cl. H01H 1/64; H01H 31/02; H02G 7/16

(52) U.S. Cl. CPC H01H 1/64; H01H 31/026; H02G 7/16

(57) ABSTRACT

A switch assembly that includes a cutout mounted fault interrupting switching device and ice shields that block ice build-up on the assembly that may otherwise impede a dropout operation of the switching device. The switching device includes a switch, an upper electrical contact and a lower electrical contact. The switch assembly includes an upper coupling assembly configured to releasably engage the upper electrical contact and a lower coupling assembly configured to engage the lower electrical contact in a pivoting engagement, where the switching device is operable to pivot relative to the lower coupling assembly when the upper electrical contact is released from the upper coupling assembly. The switch assembly further includes an upper ice shield coupled to and formed over the upper coupling assembly and a lower ice shield coupled to and formed over the lower coupling assembly.

### CROSS-REFERENCE TO RELATED APPLICATION

This application claims the benefit of priority from the U.S. Provisional Application No. 63/586,014, filed on Sep. 28, 2023, the disclosure of which is hereby expressly incorporated herein by reference for all purposes.

### BACKGROUND

### Field

This disclosure relates generally to a cutout mounted fault interrupting device including an ice shield and, more particularly, to a cutout mounted fault interrupting device including a top contact ice shield covering an upper contact mounting assembly and hinge contact ice shield covering a lower contact mounting assembly.

### Discussion of the Related Art

An electrical power distribution network, often referred to as an electrical grid, typically includes power generation plants each having power generators, such as gas turbines, nuclear reactors, coal-fired generators, hydro-electric dams, etc. The power plants provide power at a variety of medium voltages that are then stepped up by transformers to a high voltage AC signal to be connected to high voltage transmission lines that deliver electrical power to substations typically located within a community, where the voltage is stepped down to a medium voltage for distribution. The substations provide the medium voltage power to three phase feeders including three single phase feeder lines that carry the same current but are 120° apart in phase. three phase and single phase lateral lines are tapped off of the feeder that provide the medium voltage to various distribution transformers, where the voltage is stepped down to a low voltage and is provided to loads, such as homes, businesses, etc. Power distribution networks of the type referred to above typically include switching devices, breakers, reclosers, interrupters, etc. that control the flow of power throughout the network.

Periodically, faults occur in the distribution network as a result of various things, such as animals touching the lines, lightning strikes, tree branches falling on the lines, vehicle collisions with utility poles, etc. Faults may create a short-circuit that increases the stress on the network, which may cause the current flow to significantly increase, for example, many times above the normal current, along the fault path. This amount of current causes the electrical lines to significantly heat up and possibly melt, and also could cause mechanical damage to various components in the network. These faults are often transient or intermittent faults as opposed to a persistent or bolted fault, where the thing that caused the fault is removed a short time after the fault occurs, for example, a lightning strike. In such cases, the distribution network will almost immediately begin operating normally after a brief disconnection from the source of power.

Traditionally, a fuse is employed as a primary overload protection device for protecting distribution transformers and other devices that has a certain rating so that the fuse will operate above a transformer inrush current, but below a transformer through fault protection withstand or damage curve. However, fuses often create an arc when they operate, which has obvious dangers and drawbacks.

It has become increasingly popular to replace the traditional fuse with a cutout mounted fault interrupting device that employs a vacuum interrupter and a magnetic actuator to operate the vacuum interrupter. A vacuum interrupter is a switch that employs opposing contacts, one fixed and one movable, positioned within a vacuum enclosure. When the vacuum interrupter is opened by operating the magnetic actuator to move the movable contact away from the fixed contact to prevent current flow through the interrupter a plasma arc is created between the contacts that is contained and quickly extinguished by the vacuum at the next zero current crossing. When fault current is detected by the device the vacuum interrupter is opened and the device is released or “drops out” from its mounting indicating that it has operated.

Fault interrupters, for example, cutout mounted, single phase self-powered reclosers that employ vacuum interrupters and magnetic actuators, are also provided as protection devices on utility poles. These reclosers typically detect the current and/or voltage on the line to monitor current flow and have controls that indicate problems with the network circuit, such as detecting a high current fault event. If such a high fault current is detected the vacuum interrupter is opened in response thereto, and then after a short delay closed to determine whether the fault is a transient fault. If high fault current flows when the recloser is closed after opening, it is immediately re-opened. If the fault current is detected a second time, or multiple times, during subsequent opening and closing operations indicating a persistent fault, then the recloser remains open and it may drop out of its mounting indicating that it is locked open, where the time between detection tests may increase after each test.

As mentioned, these types of fault interrupting devices that are installed in cutout mountings typically cause the device to drop out of the mounting after clearing a fault on the line. The purpose of the dropout operation is to provide an open air gap as a visual indication that the line downstream is isolated and increase the long term dielectric strength across the mounting when the open device cannot provide the required dielectric strength. During dropout operation some fault interrupting devices rely on gravity to swing the device to the open and dropped out position.

Ice storms and other weather conditions can deposit ice on a fault interrupting device and it's mounting, sometimes up to 0.750 inches thick, which often impedes the dropout operation. Some fault interrupting devices of the type described above that operate as fuses utilize expulsion or arc energy to help break ice deposits during the dropout operation. Larger fault interrupting devices utilize the heavy mass of the device to break the ice during the dropout operation. In the case for certain lighter weight fault interrupting devices the lighter mass is often not enough to break the ice build-up, which can prevent the dropout operation.

### SUMMARY

The following discussion discloses and describes a switch assembly that includes a cutout mounted fault interrupting switching device and ice shields that block ice build-up on the assembly that may otherwise impede a dropout operation of the switching device. The switching device includes a switch, an upper electrical contact and a lower electrical contact. The switch assembly includes an upper coupling assembly configured to releasably engage the upper electrical contact and a lower coupling assembly configured to engage the lower electrical contact in a pivoting engagement, where the switching device is operable to pivot relative to the lower coupling assembly when the upper electrical contact is released from the upper coupling assembly. The switch assembly further includes an upper ice shield coupled to and formed over the upper coupling assembly and a lower ice shield coupled to and formed over the lower coupling assembly.

Additional features of the disclosure will become apparent from the following description and appended claims, taken in conjunction with the accompanying drawings.

### BRIEF DESCRIPTION OF THE DRAWINGS

FIG. 1 is an isometric view of a known switch assembly connected to a pole mounted insulator and including a cutout mounted magnetically actuated switching device shown in an installed position;

FIG. 2 is an isometric view of the switch assembly showing the switching device in a dropout position;

FIG. 3 is a broken-away isometric view of the switch assembly illustrating a top contact ice shield; and

FIG. 4 is a broken-away isometric view of the switch assembly illustrating a hinge contact ice shield.

### DETAILED DESCRIPTION OF THE EMBODIMENTS

The following discussion of the embodiments of the disclosure directed to a cutout mounted fault interrupting device including ice shields is merely exemplary in nature, and is in no way intended to limit the disclosure or its applications or uses.

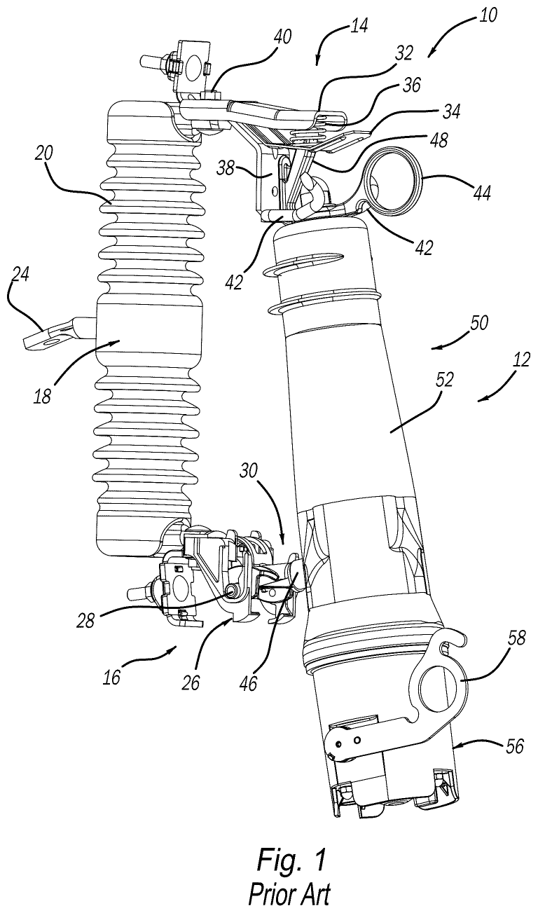

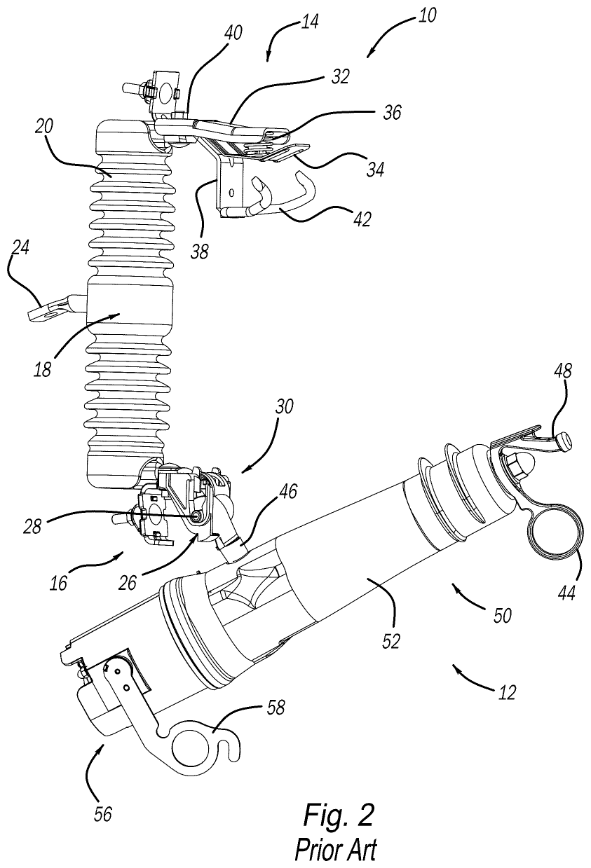

FIGS. 1 and 2 are isometric views of a known pole mounted switch assembly 10 including a cutout mounted magnetically actuated fault interrupting switching device 12, where the switching device 12 is shown in an installed position in FIG. 1 and is shown in a dropout position in FIG. 2, and where the switching device 12 is intended to represent any switching device suitable for the purposes discussed herein. The switching device 12 is coupled to an upper coupling assembly 14 at a top end and a lower coupling assembly 16 at a bottom end. The upper assembly 14 is secured to one end of an insulator 18 having skirts 20 and the lower assembly 16 is secured to an opposite end of the insulator 18, where the insulator 18 is mounted to a bracket 24 that may be attached to a utility pole (not shown). The lower assembly 16 includes a cutout hinge 26 that accepts a pivot rod 28 on a trunnion assembly 30 having a trunnion 46 coupled to the device 12 and that is electrically coupled to a unit bottom contact (not shown). The upper assembly 14 includes a top mounting tab 32, an extension tab 34 and a spring 36 positioned between the tabs 32 and 34. The upper assembly 14 also includes a support tab 38 bolted to the mounting tab 32 by a bolt 40 and a pair of mounting horns 42 coupled to and extending from the support tab 38 opposite to the extension tab 34. A unit top contact 48 is positioned between the horns 42 and engages the tab 34 against the bias of the spring 36 to hold the switching device 12 in the upper assembly 14. A guiding pull ring member 44 is coupled to a top of the device 12 and allows a worker to easily remove the device 12 from the utility pole by pulling on the ring member 44 to disengage the contact 48 from the upper assembly 14, rotating the device 12 outward on the pivot rod 28 and then lifting the device 12 out of the hinge 26.

The switching device 12 includes a vacuum interrupter assembly 50 having an outer insulation housing 52 that encloses a vacuum interrupter of the type referred to above, where the vacuum interrupter assembly 50 is representative of any vacuum interrupter assembly known in the art for medium voltage uses that is suitable for the purposes discussed herein. More particularly, the vacuum interrupter defines a vacuum chamber that encloses a fixed contact that is electrically coupled to the unit top contact 48 and a movable contact that is electrically coupled to the unit bottom contact, where the fixed and movable contacts are in contact with each other within the vacuum chamber when the vacuum interrupter is closed. When the vacuum interrupter is opened by moving the movable contact away from the fixed contact the arc that is created between the contacts is extinguished by the vacuum at a zero current crossing.

The switching device 12 also includes an enclosure 56 that encloses a magnetic actuator or other device that opens and closes the vacuum interrupter, various electronics, controllers, energy harvesting devices, sensors, communications devices, etc. consistent with the discussion herein.

Operation or opening of the vacuum interrupter in response to fault current causes the switching device 12 to move downward and the contact 48 to be released from the upper assembly 14 so that the switching device 12 rotates on the rod 28 under the force of gravity to the dropout position. Once the fault is removed, the vacuum interrupter can be closed using, for example, a mechanical lever 58 and the switching device 12 can then be re-engaged with the upper assembly 14 using the ring 44.

As discussed above, certain weather conditions can cause ice to build-up on the switch assembly 10 and prevent the switching device 12 from dropping out, thus preventing the benefits of observing the opened device 12. This disclosure proposes providing ice shields that cover the upper coupling assembly 14 and the lower coupling assembly 16 so that ice forms on the shields and not on the components of the assemblies 14 and 16, which may otherwise prevent them from operating properly.

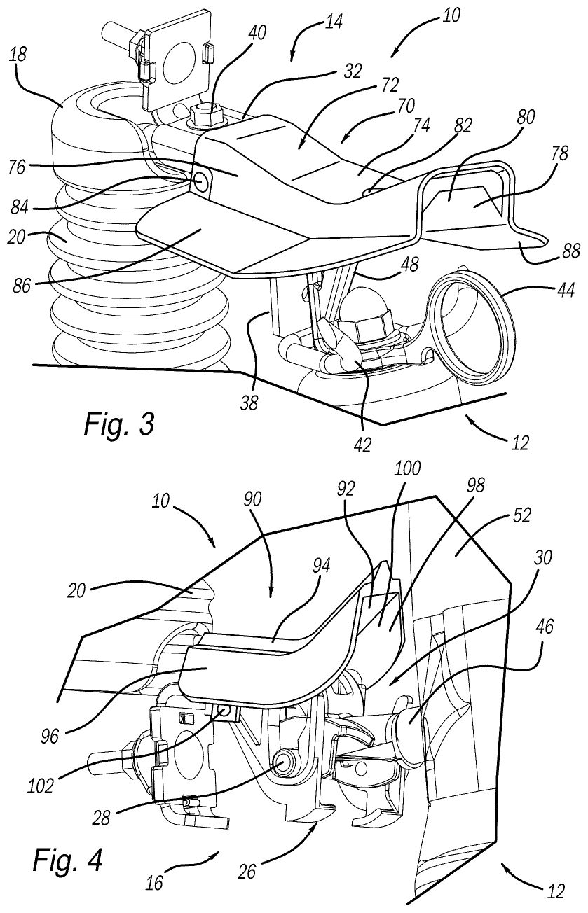

FIG. 3 is a broken-away isometric view of the switch assembly 10 illustrating a top contact ice shield 70 mounted on top of the upper coupling assembly 14 that protects ice from building up between the assembly 14 and the top of the switching device 12. In one non-limiting embodiment, the shield 70 is a single-piece aluminum member that has been stamped and rolled into the desired size and configuration to suitably cover the assembly 14 and prevent birds from using the shield 70 as a perch or nesting on top or below the shield 70. The shield 70 includes a curved center portion 72 that is angled upward at an end opposite to the insulator 18 and having a top plate 74 and side plates 76 and 78 defining a channel 80. The center portion 72 is positioned on the mounting tab 32 and secured thereto using expandable rivets 82 and a clamping screw 84 to allow quick and easy assembly with hot line gloves. The shield 70 also includes an angled side wing 86 extending from the side plate 76 and an angled side wing 88 extending from the side plate 78 that are angled downward to drain water away from the top contact 48.

FIG. 4 is a broken-away isometric view of the switch assembly 10 illustrating a hinge contact ice shield 90 mounted on top of the lower coupling assembly 14 that protects ice from building up on the assembly 16 and the switching device 12. In one non-limiting embodiment, the shield 90 is a single-piece aluminum member that has been stamped and rolled into the desired size and configuration to suitably cover the assembly 16 and prevent birds from using the shield 90 as a perch or nesting on top or below the shield 90. The shield 90 includes a curved top plate 92 that is angled upward at an end opposite to the insulator 18 and a rounded center rib 94 extending along the top plate 92. The shield 90 also includes a curved side plate 96 extending down from one side of the top plate 92 and a curved side plate 98 extending down from the opposite side of the top plate 92, where the top plate 92 and the side plates 96 and 98 define a channel 100. The shield 90 is secured to the assembly 16 by sliding features of the hinge 26 into the channel 100 and locking the shield 90 in place using push-in rivets (not shown) and a clamping screw 102.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A switch assembly comprising:
a switching device including a switch, an upper electrical contact and a lower electrical contact;
an upper coupling assembly configured to releasably engage the upper electrical contact;
a lower coupling assembly configured to engage the lower electrical contact in a pivoting engagement, wherein the switching device is operable to pivot relative to the lower coupling assembly when the upper electrical contact is released from the upper coupling assembly; and
an upper ice shield coupled to and formed over the upper coupling assembly.

2. The switch assembly according to claim 1 wherein the upper ice shield includes a center portion having an upwardly angled end.

3. The switch assembly according to claim 2 wherein the center portion includes a top plate and opposing side plates defining a channel, the upper coupling assembly being positioned within the channel.

4. The switch assembly according to claim 3 wherein the upper ice shield includes a first side wing extending down from one of the side plates and a second side wing extending down from the other side plate.

5. The switch assembly according to claim 1 further comprising a lower ice shield coupled to and formed over the lower coupling assembly.

6. The switch assembly according to claim 5 wherein the lower ice shield includes a top plate having an upwardly angled end.

7. The switch assembly according to claim 6 wherein the lower ice shield further includes opposing side plates extending down from the top plate so that the top plate and the side plates define a channel, the lower coupling assembly being positioned within the channel.

8. The switch assembly according to claim 6 wherein the lower ice shield further includes a rounded rib extending along the length of the top plate.

9. The switch assembly according to claim 1 wherein the switching device is a fault interrupting device.

10. The switch assembly according to claim 9 wherein the switch is a vacuum interrupter.

11. A switch assembly comprising:
a switching device including a switch, an upper electrical contact and a lower electrical contact;
an upper coupling assembly configured to releasably engage the upper electrical contact;
a lower coupling assembly configured to engage the lower electrical contact in a pivoting engagement, wherein the switching device is operable to pivot relative to the lower coupling assembly when the upper electrical contact is released from the upper coupling assembly; and
a lower ice shield coupled to and formed over the lower coupling assembly.

12. The switch assembly according to claim 11 wherein the lower ice shield includes a top plate having an upwardly angled end.

13. The switch assembly according to claim 12 wherein the lower ice shield further includes opposing side plates extending down from the top plate so that the top plate and the side plates define a channel, the lower coupling assembly being positioned within the channel.

14. The switch assembly according to claim 12 wherein the lower ice shield further includes a rounded rib extending along the length of the top plate.

15. The switch assembly according to claim 11 wherein the switching device is a fault interrupting device.

16. The switch assembly according to claim 16 wherein the switch is a vacuum interrupter.

17. A pole-mounted switch assembly comprising:
a fault interrupting switching device including a vacuum interrupter, an upper electrical contact and a lower electrical contact;
an upper coupling assembly configured to releasably engage the upper electrical contact;
a lower coupling assembly configured to engage the lower electrical contact in a pivoting engagement, wherein the switching device is operable to pivot relative to the lower coupling assembly when the upper electrical contact is released from the upper coupling assembly;
an upper ice shield coupled to and formed over the upper coupling assembly; and
a lower ice shield coupled to and formed over the lower coupling assembly.

18. The switch assembly according to claim 17 wherein the upper ice shield includes a center portion having an upwardly angled end, wherein the center portion includes a top plate and opposing side plates defining a channel, the upper coupling assembly being positioned within the channel, the upper ice shield further including a first side wing extending down from one of the side plates and a second side wing extending down from the other side plate.

19. The switch assembly according to claim 17 wherein the lower ice shield includes a top plate having an upwardly angled end, opposing side plates extending down from the top plate so that the top plate and the side plates define a channel, the lower coupling assembly being positioned within the channel, and a rounded rib extending along the length of the top plate.
